(19) United States
(12) Patent Application Publication
(10) Pub. No.: US 2011/0252656 A1
(43) Pub. Date: Oct. 20, 2011

(54) CROWNED ROLL MEASURING ARM

(75) Inventors: Sam Moore, Brandon, MS (US); Charles M. Meadows, Brandon, MS (US); Joe Bagwell, Silver Creek, MS (US)

(73) Assignee: Double G Coatings Company, L.P., Jackson, MS (US)

(21) Appl. No.: 12/761,579

(22) Filed: Apr. 16, 2010

(51) Int. Cl. G01C 9/26

(52) U.S. Cl. 33/370

(57) ABSTRACT

A device for leveling crowned rolls is disclosed. The crowned roll measuring arm reduces the amount of time and effort required to level crowned rolls. The crowned roll measuring arm spans the curve of the crowned roll, but still allows for precise leveling.

### FIELD OF THE INVENTION

The present invention is generally directed toward a device for leveling a crowned roll.

### BACKGROUND OF THE INVENTION

Properly leveled rolls in a manufacturing process line ensure that the material traveling atop the rolls tracks straight along the intended path in the process line. Rolls that are not level will cause the material being transported to veer off track, usually to the high side of the roll, due to increased tension on the high side. Unlevel rolls can also result in stretching of the transported material at one edge due to the difference in distance between an unlevel roll and the adjacent roll. This stretching could result in permanent deformation of the material. For cylindrical rolls, leveling may be accomplished by placing the level atop the center of the roll body and shimming the bearing blocks as needed to bring the level bubble to center.

Crowned rolls, however, are more difficult to level. Crowned rolls have a diameter that is larger in the middle than at the ends. The shape of the rolls helps keep conveyer belts or other objects properly aligned over the center of the rolls. The curvature of the roller body along the length of the roller makes leveling the roller difficult because the standard machinist level cannot be placed flat against the roll. Leveling crowned rolls with a machinist level would be very imprecise and time consuming because the level would rock up and down against the body of the roller.

In certain circumstances, an optical or laser leveling device could be employed to shoot the crowned roll bearing centers. However, this technique can only be used when it is possible to mount the leveling device on a stable surface and still “see” both ends of the roll bearing centers. Furthermore, the accuracy of this technique is highly subject to the skill of the technician.

Process lines often contain hundreds of crowned rolls, and getting each crowned roll level could take a significant amount of time. Because the process line is not functional until the rolls are level, there is a direct loss of productivity and financial cost to the facility.

### SUMMARY OF THE INVENTION

The presently disclosed device allows a technician to quickly and precisely level a crowned roller. The device spans or bridges the roll curvature in a way that enables the use of a machinist level to level the roll. Small perpendicular levels at the ends of the crowned roll measuring arm are used to ensure that the device is at the top-center of and parallel to the roll being leveled. Built-in magnets lock the device to the roll in order to ensure that it stays properly positioned as the machinist level is laid in a machined window atop the device. As with leveling cylindrical rolls, the crowned roll bearings are then shimmed to bring the level bubble to center.

The great advantage of the crowned roll measuring arm is that any nominally trained maintenance technician can utilize a simple, easy to read and understand, low-cost precision machinist level to level crowned rolls with consistent and highly accurate results, regardless of the stability of adjacent work platforms and roll configuration in the process line.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of the crowned roll measuring arm mounted on a crowned roll.

FIG. 2 is a perspective view of the crowned roll measuring arm.

FIG. 3 is a side view of the crowned roll measuring arm.

FIG. 4 is a bottom plan view of the crowned roll measuring arm.

FIG. 5 is a top plan view of the crowned roll measuring arm.

FIG. 6 is a cross-sectional view of the crowned roll measuring arm as viewed along line 6-6 of FIG. 5.

FIG. 7 is a side elevational view of the crowned roll measuring arm.

FIG. 8 is a an exploded diagram of the crowned roll measuring arm.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

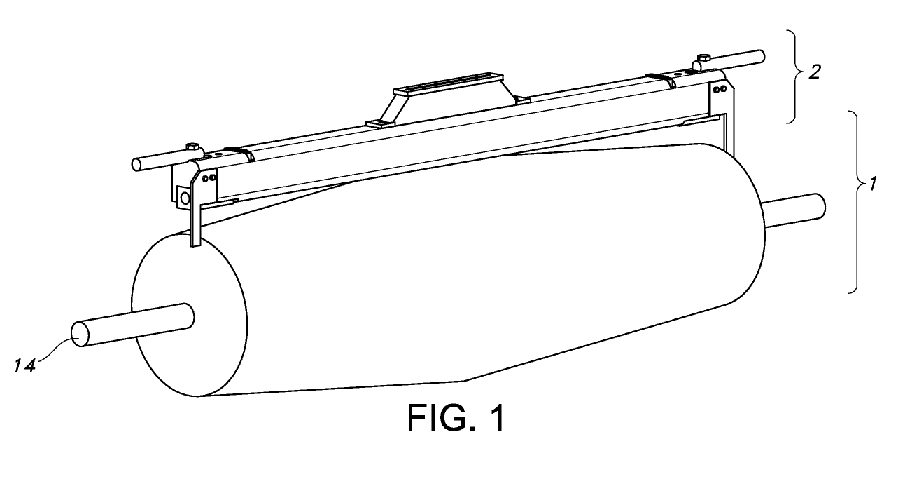

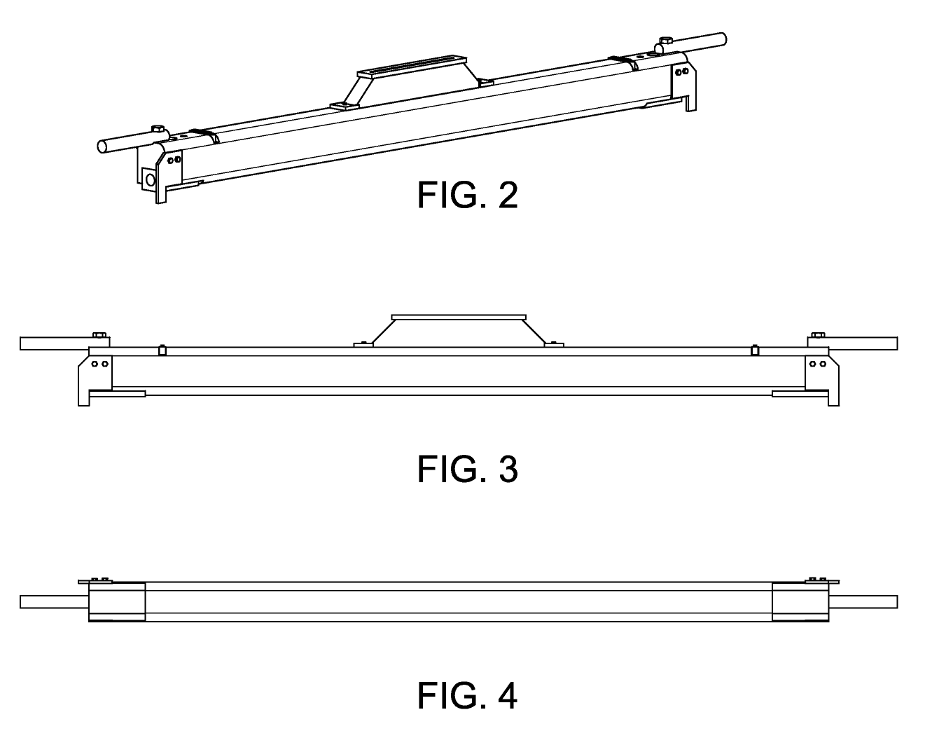

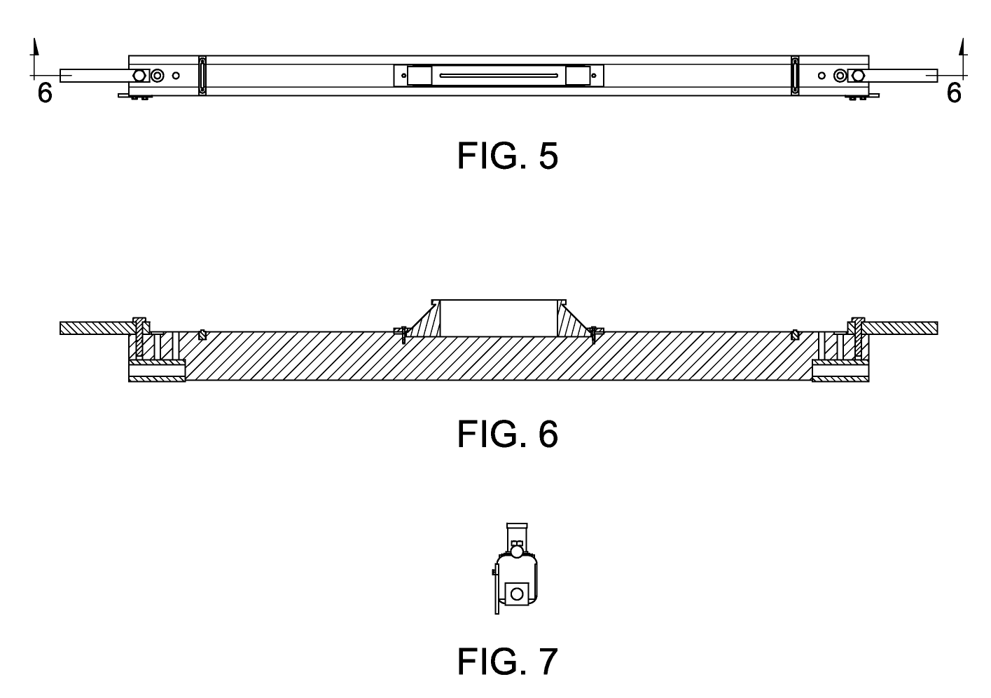

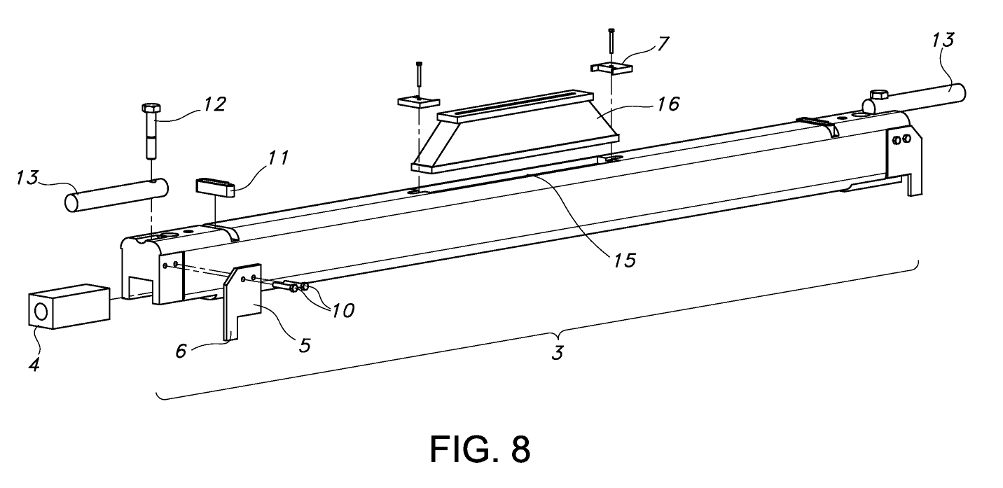

Referring to the drawings, FIG. 1 illustrates an exemplary embodiment of the crowned roll measuring arm as mounted on a crowned roll 1. Although a crown roll with a sharp degree of tapering is illustrated, the invention works well even on crown rolls with slight tapering, as found in most process lines.. The body 3 of the crowned roll measuring arm is made of a straight bar that is close in length to the length of the crowned roll 1 being leveled. The body 3 can be made from any hard material, but machined aluminum is preferred because it results in a lower overall weight of the crowned roll measuring arm compared to other metals.

End roll positioning plates 5 are mounted on both ends of body 3. These end roll positioning plates 5 are made of a machined hard metal or alloy, such as steel, and are shaped to include an extended portion 6 that is longer than the difference between the diameter of crowned roll 1 at the crown and the diameter of the crowned roll 1 at its ends. The end roll positioning plates 5 are mounted on the bar such that the distance between the extended portions 6 is just great enough to accommodate the length of crowned roll 1. When the crowned roll measuring arm is placed along the top of the crowned roll 1, the extended portions 6 of end roll positioning plates 5 should fit snugly against the edge of the crowned roll 1.

The crowned roll measuring arm includes top-center levels 11 located close to the ends of the body 3. These levels are bubble levels that allow the operator to locate the top-center of each side of crowned roll 1. As used herein, the top-center of a roll is located vertically above the central axis of a roll.

At both ends of the crowned roll measuring arm are locking magnets 4. These locking magnets 4 help hold the device in place after the top-centers of each side of crowned roll 1 are located. The locking magnets 4 may optionally be engaged by use of a switch that activates the locking magnets 4 by pushing them closer to the crowned roll 1. When the locking magnets 4 are not engaged, the operator can freely move the crowned roll measuring arm to position it at the top-center of the crowned roll 1. When the locking magnets 4 are engaged, the crowned roll measuring arm is harder to move.

Once the crowned roll measuring arm has been positioned such that both ends are at top-center of the crowned roll 1, the crowned roll 1 can be leveled. The crowned roll measuring arm includes a machined-out slot 15 at the top of body 3 in which primary level 16 can be placed. Primary level 16 may be supplied by the operator, or may be provided with the crowned roll measuring arm. Level keepers 7 held in place by screws may be used to secure the primary level 16 to the body 3.

To level the crowned roll 1, the operator would simply lift the ends of the crowned roll 1 until the primary level 16 indicates that the crowned roll 1 is level. Shims would be placed under the roll shaft bearing blocks to level the crowned roll 1, and the bearing foot bolts of the crowned roll 1 would be tightened to secure the assembly.

Once the leveled crowned roll 1 has been secured, the operator would disengage the locking magnets 4 and lift the crowned roll measuring arm off of the crowned roll 1.

In one embodiment, the crowned roll measuring arm can accept end roll positioning plates 5 of varying lengths in order to accommodate rolls of varying lengths. The end roll positioning plates 5 may be attached with bolts 10 so that they can easily be interchanged with end roll positioning plates 5 that properly accommodate the length of the crowned roll 1.

Because the crowned roll measuring arm may be very heavy, it may optionally includes handles 13 that are secured with handle bolts 12. The handles 13 allow the crowned roll measuring arm to be maneuvered with greater ease as the operator locates top-center of the crowned roll 1.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques, other than those specifically described herein, can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents, including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A device for leveling a roll in a process line comprising:
a. an elongated bar having levels near both ends of said elongated bar, said levels oriented to determine the top-center of said roll;
b. a receptacle for receiving a machinist level;
c. positioning plates affixed at both ends of said elongated bar, said positioning plates configured such that each plate comes into contact with one end of said roll when said elongated bar is placed on top of said roll.

2. The device of claim 1 further comprising a magnetic lock for locking the leveling device to the roll

3. The device of claim 1 further comprising handles affixed to said elongated bar.

4. A device for leveling a roll in a process line comprising:
a. an elongated bar having levels near both ends of said elongated bar, said levels oriented to determine the top-center of said roll;
b. a machinist level affixed to said elongated bar;
c. positioning plates affixed at both ends of said elongated bar, said positioning plates configured such that each plate comes into contact with one end of said roll when said elongated bar is placed on top of said roll.

5. The device of claim 4 further comprising a magnetic lock for locking the leveling device to the roll

6. The device of claim 4 further comprising handles affixed to said elongated bar.
